(19) United States
(12) Patent Application Publication
(10) Pub. No.: US 2016/0381508 A1
(43) Pub. Date: Dec. 29, 2016

(54) Location-Based Prefetch and Participant-Based Prefetch

(71) Applicant: ChengDu HaiCun IP Technology LLC, ChengDu (CN)

(72) Inventor: Guobiao ZHANG, Corvallis, OR (US)

(73) Assignee: ChengDu HaiCun IP Technology LLC, ChengDu (CN)

(21) Appl. No.: 15/260,264

(22) Filed: Sep. 8, 2016

Related U.S. Application Data
(63) Continuation of application No. 14/637,376, filed on Mar. 3, 2015, now abandoned.
Application No. 14/637,376 is a continuation of application No. 13/856,605, filed on Apr. 4, 2013, now abandoned.
(60) Provisional application No. 61/620,979, filed on Apr. 5, 2012.

(51) Int. Cl. H04W 4/02; G06Q 10/10; H04L 29/08

(52) U.S. Cl. CPC H04W 4/023; H04L 67/18; G06Q 10/1095

(57) ABSTRACT

To reduce the mobile data usage, information associated with scheduled future events is prefetched via an inexpensive mass-data transfer link (e.g., Wi-Fi, Ethernet, or off-peak mobile broadband) and does not need to be fetched via an expensive mobile communication link (e.g., mobile broadband) during normal usage. Location-based prefetch and participant-based prefetch can leverage the existing infrastructures of location-based services (LBS) and social networking services (SNS).

### CROSS-REFERENCE TO RELATED APPLICATIONS

This is a continuation of an application “Location-Based Prefetch and Participant-Based Prefetch”, application Ser. No. 14/637,376, filed Mar. 3, 2015, which is a continuation of an application “Location-Based Prefetch and Participant-Based Prefetch”, application Ser. No. 13/856,605, filed Apr. 4, 2013, which claims benefits of a provisional application “Location-Based Prefetching System”, application Ser. No. 61/620,979, filed Apr. 5, 2012.

### BACKGROUND

1. Technical Field of the Invention

The present invention relates to the field of electronic system, and more particularly to mobile communication between an electronic device and Internet.

2. Prior Arts

Mobile Internet combines mobile communication and Internet. It allows Internet access from a mobile device over a wide geographic area. Consumers can purchase a mobile broadband modem (e.g., a 3G USB dongle) or other equipment to connect their computer (e.g., PC, laptop) to the Internet. In addition, many mobile devices (e.g., smart-phone, tablet) have built-in support for mobile broadband. Compared with fixed-line Internet access, mobile Internet access incurs significantly higher on-line expenses.

Consumers naturally desire to have low-cost or even free mobile Internet access. In the past, attempts have been made to provide low-cost or even free fixed-line Internet access, particularly dial-up Internet access. To get free dial-up Internet access from service providers such as Netzero, a user runs a client application that makes an advertising window visible and on top of other windows throughout the entire on-line session. By displaying advertisements for third parties to users, Netzero derives revenue and uses that revenue to discount the users' on-line expenses.

The Netzero's method of discounting on-line expenses for dial-up Internet access cannot be applied to mobile Internet access. Because dial-up Internet access is charged by connection time, advertisements can be sent to a user during a dial-up Internet session without incurring extra charges. However, because mobile Internet access is charged by data usage, sending advertisements to a user during a mobile Internet session increases data usage and therefore, incurs additional on-line expenses.

### OBJECTS AND ADVANTAGES

It is a principle object of the present invention to provide low-cost or even free mobile Internet access.

It is a further object of the present invention to reduce mobile data usage.

It is a further object of the present invention to improve responsiveness of mobile Internet access.

It is a further object of the present invention to improve the prefetch efficiency.

It is a further object of the present invention to better predict future events.

It is a further object of the present invention to provide an easy-to-implement prefetch system.

It is a further object of the present invention to lower the cost of prefetch hardware.

In accordance with these and other objects of the present invention, the present invention discloses system and method for location-based prefetch and participant-based prefetch.

### SUMMARY OF THE INVENTION

The present invention discloses a prefetch system supporting location-based prefetch and/or participant-based prefetch. It comprises a mobile device, a prefetch server and an information network. During a prefetch session, a mobile device predicts events that will likely occur to a user (i.e., future events) and transmits the future event information to a prefetch server. The prefetch server selects information associated with future events (i.e., event specific information) and transmits the event specific information back to the mobile device via an inexpensive mass-data transfer link (e.g., Wi-Fi, Ethernet or off-peak mobile broadband). The mobile device stores the prefetched information as part of internal web. During a mobile Internet session, the requested information is only retrieved from the information network (i.e., external web) via an expensive mobile communication link (e.g., mobile broadband) if it is not in the internal web. Hence, mobile data usage is reduced.

During the prefetch session, if a web site is associated with a future event, the prefetch server transmits its web object, which contains a collection of web pages from this web site, to the mobile device. Depending on the prefetch service a web site subscribes to, different amount of web pages are included in its web object. For example, the web object may include only the front page of the web site if a basic prefetch service is subscribed to; and the web object may include more web pages if a higher level of prefetch service is subscribed to. Because a web site are more likely viewed by a user if more of its web pages are prefetched, the web-site owner has incentive to pay a fee to subscribe to a higher level of prefetch service. This fee, together with advertisement revenue, can be used to discount the mobile Internet access charge. Eventually, they will lead to free mobile Internet access.

For location-based prefetch, the prefetched information is associated with the locations of future events (i.e., future locations, which could be different from the current location of the mobile device) and is location specific information. On the other hand, for participant-based prefetch, the prefetched information is associated with the participants of future events (i.e., future participants, which could be different from the owner of the mobile device) and is participant specific information. Because they can leverage the existing infrastructures for location-based services (LBS) and social networking services (SNS), location-based and participant-based prefetch are easy to implement and may lower the cost of prefetch hardware.

To improve prefetch efficiency, future events need to be predicted as accurately as possible. Future events can be categorized into guessed future events and scheduled future events: the guessed future events are guessed from past events, while the scheduled future events are specified by a user (generally inputted into a calendaring application). Because they are specified by the user, the scheduled future events are more accurate than the guessed future events. Only when the scheduled future events are not available, the guessed future events are used.

### BRIEF DESCRIPTION OF THE DRAWINGS

FIG. 1 is a schematic view of a preferred prefetch system;

FIG. 2 is a block diagram of a preferred mobile device;

FIG. 3 is a block diagram of a preferred prefetch application;

FIGS. 4A-4C are block diagrams of three preferred prefetch servers;

FIG. 5 is a flow chart of an overall information retrieval process;

FIGS. 6A-6C are flow charts of three preferred information retrieval processes during a prefetch session;

FIGS. 7A-7C are flow charts of three preferred information retrieval processes during a mobile Internet session.

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

In the present invention, the symbol “/” means a relationship of “and” or “or”. For example, “location/participant” means “location only”, or “participant only”, or “location and participant”; “location/participant/action” means “location only”, or “participant only”, or “action only”, or “location and participant”, or “participant and action”, or “action and location”, or “location and participant and action”.

Referring now to FIG. 1, a preferred prefetch system is disclosed. It comprises an information network 00, a mobile device 10 and a prefetch server 50. During a prefetch session, the mobile device 10 prefetches information from the prefetch server 50 via a first mass-data transfer link 110. In certain embodiments, the mobile device 10 may also directly prefetch information from the information network 00 via a second mass-data transfer link 110*. During a mobile Internet session (e.g., during normal usage), the mobile device 10 may fetch information from the information network 00 via a mobile communication link 120. Separately, the prefetch server 50 can fetch information from the information network 00 via a third mass-data transfer link 130.

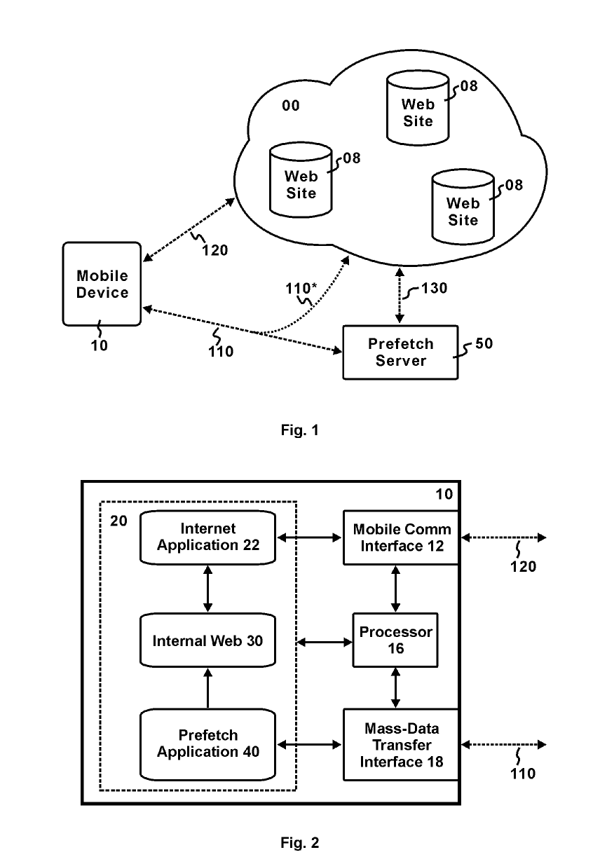

The information network 00 works as an external web for the mobile device 10, with respect to the internal web 30 of FIG. 2. It comprises a plurality of web sites 08, which store information ranging from advertisements to educational information to business data. The web site 08 could be a physical computer or a computer software dedicated to running one or more web services, to serve the needs of users of the other computers on the network.

The mobile device 10 includes virtually any electronic device comprising a mobile communication interface. As such, the device 10 may range widely in terms of capabilities and features. It could be a cellular phone, a tablet and the like. It could also be a computer (e.g., netbook, notebook, laptop, PC) with either an internal or external mobile broadband modem. Computer is suitable for prefetch because its hard-disk drive (HDD) can store a large amount of prefetched information.

The prefetch server 50 stores a prefetch database. It could be a dedicated server, a network of servers, or a part of peer-to-peer network. Peer-to-peer (P2P) refers to a computer network in which each computer in the network can act as a client or server for the other computers in the network, allowing shared access to files and peripherals without the need for a central server. P2P is attractive to prefetch because the prefetched information is common to many users. It should be appreciated that the prefetch server 50 could be part of the information network 00 or part of the mobile device 10.

The mobile communication link 120 many include any wide-area wireless connection. Examples include mobile broadband, WiMax and satellite-based link. Among them, mobile broadband is most popular. It uses cellular signals to access Internet. Mobile broadband can be realized through 2G (e.g., GSM), 2.5G (e.g., GPRS), 3G (e.g., WCDMA), 4G (e.g., LTE) and future access networks. In general, the mobile communication link 120 is expensive.

Because the mobile device 10 prefetches information from a large number of web sites 08 (e.g., from all web sites associated with a location), the amount of prefetched data is so large that these data are referred to as mass data and the communication link to transfer these mass data is referred to as mass-data transfer link 110, 110*, 130. They provide an inexpensive way to transfer mass data. A primary example of mass-data transfer link is a non-mobile communication link such as LAN (local-area network) or WAN (wide-area network) link. Among them, LAN (e.g., Wi-Fi or Ethernet) has the best potential because it is ubiquitous and provides mostly un-metered high-speed Internet connection. Another example of mass-data transfer link is a mobile communication link operated during off-peak hours, e.g., an off-peak mobile broadband link. Because the mobile data charge during off-peak hours is much lower than during peak hours, the off-peak mobile communication link can be used to transfer a large amount of data. A further example of mass-data transfer link is a broadcast/multicast link, which uses digital TV/digital radio/cellular signals.

Referring now to FIG. 2, a block diagram of the mobile device 10 is shown. The mobile device 10 comprises a mobile communication interface 12, a mass-data transfer interface 18, a processor 16, and a memory 20. The mobile communication interface 12 is coupled to the mobile communication link 120. It could be a mobile broadband modem. The mass-data transfer interface 18 is coupled to the mass-data transfer link 110. It could be a network interface controller such as LAN adapter.

The memory 20 could be a solid-state memory (e.g., flash), or hard-disk drive. It stores at least the following software components: an Internet application 22, an internal web 30 and a prefetch application 40. The Internet application 22 is operatively coupled with the mobile communication interface 12 (optionally also with the mass-data transfer interface 18). It may be, but is not limited to, a browser application, a messaging tool and the like.

The internal web 30 works as a cache for the Internet application 22. It comprises information prefetched during the prefetch sessions. Because it is much faster to access the internal web 30 than the external web 00, the internal web 30 can greatly improve the responsiveness of the mobile Internet access. On the other hand, because the memory 20, especially the solid-state memory, has a limited capacity, a high prefetch efficiency is desired, i.e., there is a high likelihood that the prefetched information will be accessed by the user during a mobile Internet session.

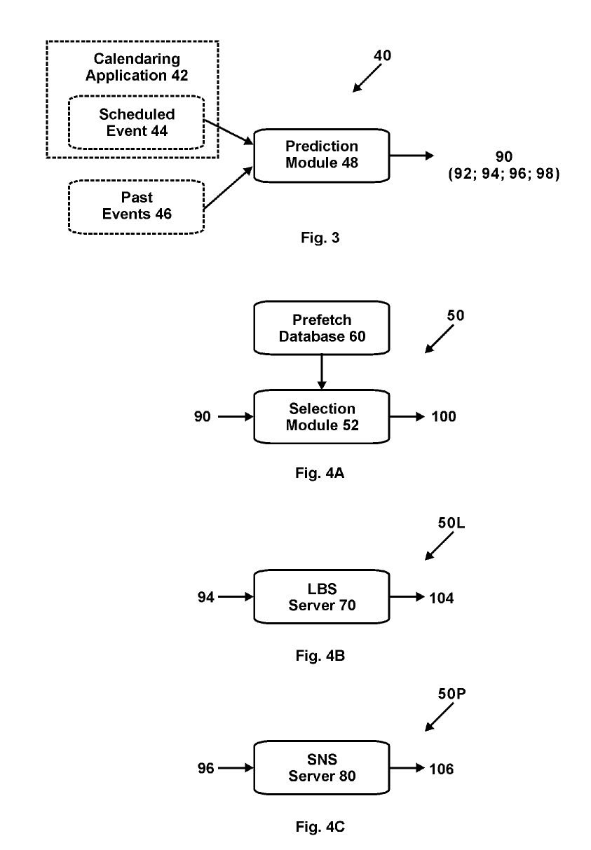

The prefetch application 40 is operatively coupled with the mass-data transfer interface 18 of the mobile device 10. Its primary function is to predict future events, i.e., events that will likely occur to a user. In order to have a high prefetch efficiency, future events need to be predicted as accurately as possible. It should be appreciated that the prefetch application 40 can also select information to be prefetched in certain embodiments. More details of the prefetch application 40 are disclosed in FIG. 3.

As illustrated in FIG. 3, a preferred prefetch application 40 primarily comprises a prediction module 48, which predicts future events 90. Each future event 90 includes the following elements: time(s) 92, location(s) 94, participant(s) 96 and action(s) 98. The time(s) 92 of the event 90 could be a single time point, multiple time points, a single period or multiple periods. The location(s) 94 of the event 90 could be one location or multiple locations. The participant(s) of the event 90 could be a single person, a group of persons, an organization or a business. The action(s) of the event 90 could be a single action or multiple actions. Hereinafter, a future event 90 can be expressed by its elements as: (time 92; location 94; participant 96; action 98).

The prediction module 48 has two inputs. One input is from a calendaring application 42, which manages scheduled events 44, i.e., future events in the user schedule. The other input is guessed from the event store, which stores past events 46, i.e., events that occurred to the user in the past.

The calendaring application 42 is an application software with which a user inputs his/her schedule (including a plurality of scheduled events 44). Calendaring is a standard feature of many PDAs, smart-phones, tablets and the like. The software may be a local package designed for individual use (e.g., Windows Calendar) or may be a networked package that allows for the sharing of information between users (e.g., Mozilla Sunbird, Windows Live Calendar, Google Calendar). The calendaring data may be stored locally in the mobile device 10. Alternatively, the calendaring data may be stored remotely. For example, the calendaring data is stored in a cellular phone, while the mobile device 10 is a computer with mobile broadband capability. These two devices synchronize the calendaring data whenever possible.

Past events 46 are a collection of event history, on-line activity history, location history and the like. The event history can be collected from the past events in the user schedule. The on-line activity history is accumulated in a statistical database by collecting the type of Internet data the user previously requested and accessed. The location history could be the GPS record of the user's cellular phone.

The prediction module 48 predicts future events 90 using both scheduled future events and guessed future events. Being more accurate, the scheduled future events are primarily used to predict future events. Only when the scheduled future events are not available, the guessed future events are used.

The following is a concrete example describing the above method. From the calendaring application 42, a user (Pi) has a scheduled meeting (action A₃) with another person (P₂) at location L₃ at 1 pm-2 pm. However, the calendaring application 42 does not specify any other events for this day. In this situation, past events 46 are used to best guess future events 90. As the user's habits are working (action A₁) at location L₁ at 9 am-12 pm, 1 pm-5 pm, having lunch (action A₂) at location L₂ at 12 pm-1 pm, this information can be used to fill the time gap in the user schedule. Accordingly, the future events 90 for this day are as follows: (9 am-12 pm; L₁; P₁; A₁); (12 pm-1 pm; L₂P₁; A₂), (1 pm-2 pm; L₃; P₁, P₂; A₃), and (2 pm-5 pm; L₁; P₁; A₁). Apparently, elements of future events may be defined differently in different prefetch systems.

Referring now to FIGS. 4A-4C, three preferred prefetch server 50 are disclosed. The prefetch server 50 in FIG. 4A is a generic prefetch server that selects information based on the future event 90. The prefetch servers 50L in FIG. 4B is a location-based prefetch server, which selects information based on the location(s) 94 of the future event 90; while the prefetch servers 50P in FIG. 4C is a participant-based prefetch server, which selects information based on the participant(s) 96 of the future event 90.

As illustrated in FIG. 4A, the preferred prefetch server 50 comprises a prefetch database 60 and a selection module 52. The prefetch server 50 receives the future event information 90 from the mobile device 10. The selection module 52 selects from the prefetch database 60 the information associated with the future event 90, i.e., event specific information 100. The prefetch server 50 then transmits the event specific information 100 back to the mobile device 10.

The prefetch database 60 includes a directory file and a large number of web objects. The directory file contains tags of each web object. These tags are categorized into time tag, location tag, participant tag, action tags and others. Hereinafter, the tags of a web object can be expressed as {time tag; location tag; participant tag; action tag}.

The following is a concrete example describing the tags of a web object, which is associated with a web site of restaurant R. Its tags are {; L₁, L₂; P₂, P₃; A₂}, which means the restaurant's web site does not change with time; the restaurant is located at locations L₁ and L₂; the people working at the restaurant are P₂ and P₃; its major business is A₂ (e.g., lunch). Apparently, tags may be defined differently in different prefetch systems.

Each web object contains a collection of web pages from a distinct web site. Depending on the prefetch service a web site subscribes to, different amount of web pages are included in its web object. For example, the web object may include only the front page of the web site if a basic prefetch service is subscribed to; and the web object may include more web pages if a higher level of prefetch service is subscribed to. Because a web site will be more likely viewed by a user when more web pages are prefetched to the mobile device 10, the web-site owner has incentive to pay a fee to subscribe to a higher level of prefetch service. This fee, together with advertisement revenue, can be used to discount the mobile Internet access charge. Eventually, they will lead to free mobile Internet access.

The selection module 52 selects web objects from the prefetch database 60. Based on a predetermined prefetch style, selected future event information is used as selection criterion. For example, if the prefetch style is location (i.e., location-based prefetch), then the location 94 of the future event 90 is used as selection criterion; if the prefetch style is participant (i.e., participant-based prefetch), then the participant 96 of the future event 90 is used as selection criterion; if the prefetch style is location and action (i.e., “location+action”-based prefetch), then the location 94 and action 98 of the future event 90 are used as selection criteria.

Once the selection criterion is determined, a selecting process is carried out by comparing the tags of the web objects with the selection criterion. If there is a match, the web object is selected and then transmitted to the mobile device 10 by the prefetch server 50. Using the same examples as described above and assuming location-based prefetch, for the future event of (12 pm-1 pm; L₂; P₁; A₂), the selection criterion is L₂ for location; thus, the web object for the restaurant R, whose tags are {“ ”; L₁, L₂; P₂, P₃; A₂}, will be selected and prefetched.

Besides the selection criterion derived from future events, other selection criterion may be applied. One selection criterion is web-page popularity. For example, a web page may be selected based on its click-through rate, i.e., the number of users that have selected the web page. Another selection criterion is the user's demographic profile, which includes grow-up location, age, occupation, gender, marital status, school information, work information, interests and hobbies. The demographic profile may include a set of key words, along with a score for each key word denoting its estimated importance. Then a score of the web object may be determined by evaluating the match between the demographic profile and the tags of the web object.

Among various prefetch styles, the location-based prefetch and participant-based prefetch are particularly advantageous. Because they can leverage the existing infrastructures for location-based services (LBS) and social networking services (SNS), the location-based prefetch and participant-based prefetch are easy to implement and may lower the cost of prefetch hardware.

LBS use location and time data as control variables for computer programs. An LBS server receives the current location of a mobile device, selects information based on the current location and transmits location specific information to the mobile device. As GPS-enabled smart-phones and tablets gain popularity, LBS becomes more and more important. It provides valuable services to mobile users. For example, LBS can send coupons or advertisements to mobile users based on their current location.

As illustrated in FIG. 4B, the location-based prefetch server 50L may be simply an LBS server 70. The LBS server 70 receives the future location information 94 from the mobile device 10, selects information associated with the future locations 94 (i.e., location specific information 104) and transmits the location specific information 104 back to the mobile device 10. Because most LBS servers 70 do not differentiate between current location and future location, valid location specific information 104 will be generated. Of course, the LBS server 70 can provide service for future locations. Apparently, other selection criteria, such as the web-page popularity and/or the user's demographic profile, can be applied to location specific information 104 to further reduce the amount of prefetched information.

SNS is an on-line service, platform, or site that focuses on facilitating the building of social networks or social relations among people. An SNS server stores the user information (e.g., profile, social links) and provides a variety of additional services. Take Facebook as an example. A user may add other users as friends, and exchange messages, including automatic notifications when they update their profile. Additionally, users may join common-interest user groups, organized by workplace, school, or other characteristics.

As illustrated in FIG. 4C, the participant-based prefetch server 50P may be simply an SNS server 80. The SNS server 80 receives the future participant information 96 from the mobile device 10, selects information associated with the future participants 96 (i.e., participant specific information 106) and transmits the participant specific information 106 back to the mobile device 10. For example, assuming the future participants 96 include P₁ and P₂, the participant specific information 106 includes the Facebook pages of P₁, P₂ and their common friends, etc. Apparently, other selection criteria, such as the web-page popularity and/or the user's demographic profile, can be applied to participant specific information 106 to further reduce the amount of prefetched information.

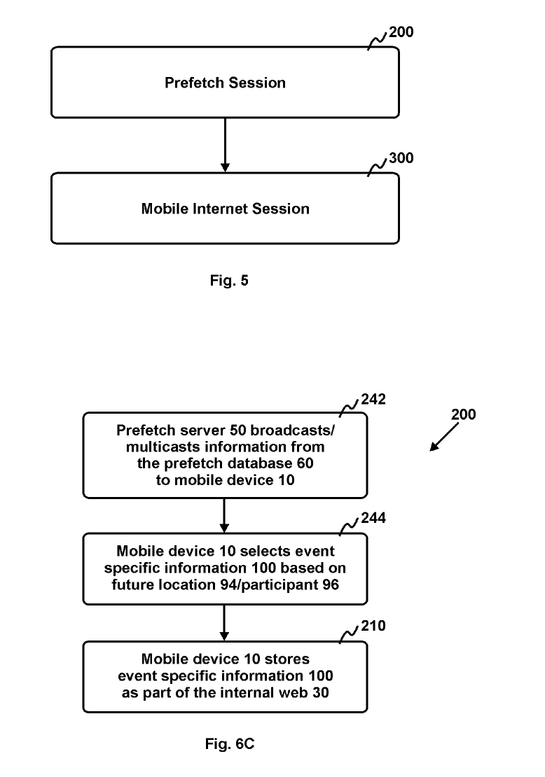

Referring now to FIG. 5, an overall information retrieval process is disclosed. It comprises two sessions: a prefetch session 200 and a mobile Internet session 300. During the prefetch session 200, the mobile device 10 prefetches the event specific information 100 via the mass-data transfer link 110. During a mobile Internet session (e.g., during normal usage), the requested information is only fetched from the external web 00 via the mobile communication link 120 if it is not in the internal web 30.

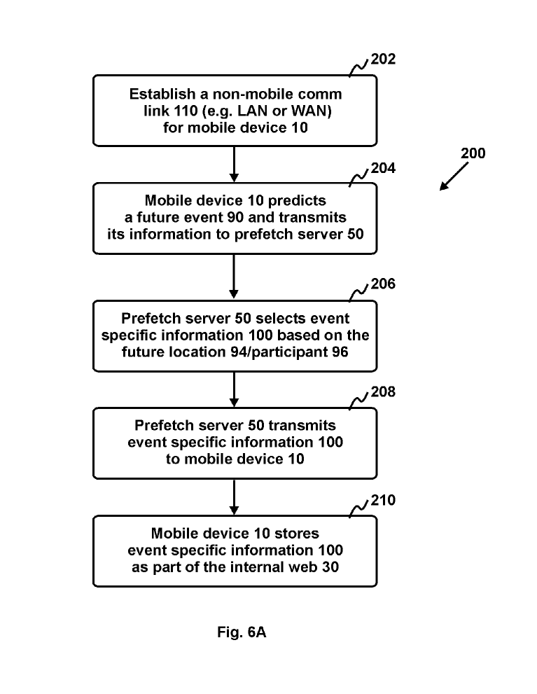

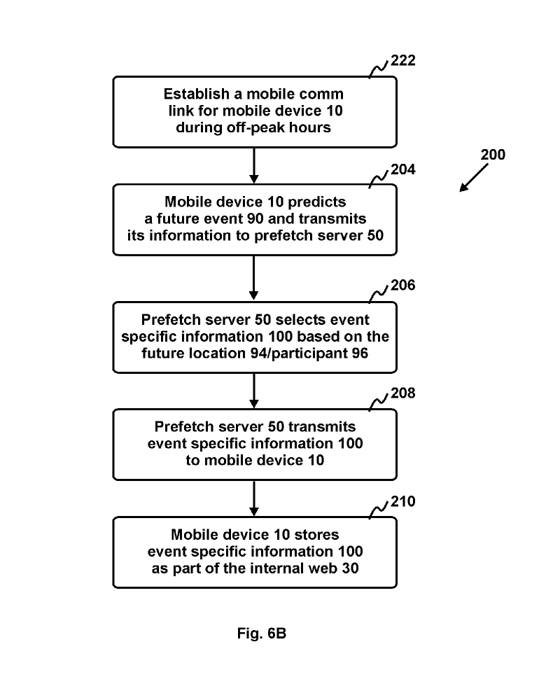

Referring now to FIGS. 6A-6C, three preferred information retrieval processes during a prefetch session 200 are disclosed. In FIG. 6A, a non-mobile communication link 110 is established between the mobile device 10 and the prefetch server 50 (optionally with the external web 00) (step 202). The non-mobile communication link 110 could be a LAN (e.g., Wi-Fi or Ethernet) or WAN link. The mobile device 10 predicts future events 90 and transmits its information to the prefetch server 50 (step 204). Once receiving the future event information 90, the prefetch server 50 selects event specific information 100, such as location specific information 104 or participant specific information 106, based on the future location(s) 94 and/or participant(s) 96 (step 206). The prefetch server 50 then transmits the event specific information 100 back to the mobile device 10 (step 208). Finally, the mobile device 10 stores the event specific information 100 as part of the internal web 30 (step 210). Apparently, this prefetch process can be carried out in background if the user is actively using the non-mobile communication link 110.

In FIG. 6B, a mobile communication link is established between the mobile device 10 and the prefetch server 50 (optionally with the external web 00) during off-peak hours, such as around mid-night (step 222). The mobile communication link operated during off-peak hours is referred to as off-peak mobile communication link. Its primary example is off-peak mobile broadband link. Because the mobile data charge during off-peak hours is much lower than during peak hours, the off-peak mobile communication link can be used to transfer a large amount of data. Other steps of this prefetch process are similar to those in FIG. 6A.

In FIG. 6C, the prefetch server 50 broadcasts/multicasts information from the prefetch database 60 to the mobile device 10 (step 242). The broadcast/multicast signals may include digital terrestrial television/radio broadcasting signals, or cellular signals. Preferably, the broadcast/multicast session occurs during off-peak hours, such as around midnight. The mobile device 10 then selects event specific information 100 based on future location 94/participant 96 (step 244). Finally, the mobile device 10 stores the event specific information 100 as part of the internal web 30 (step 210).

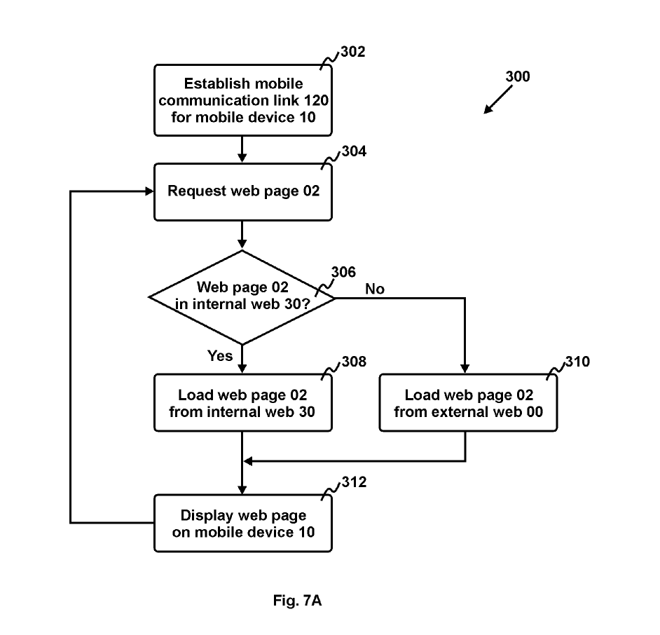

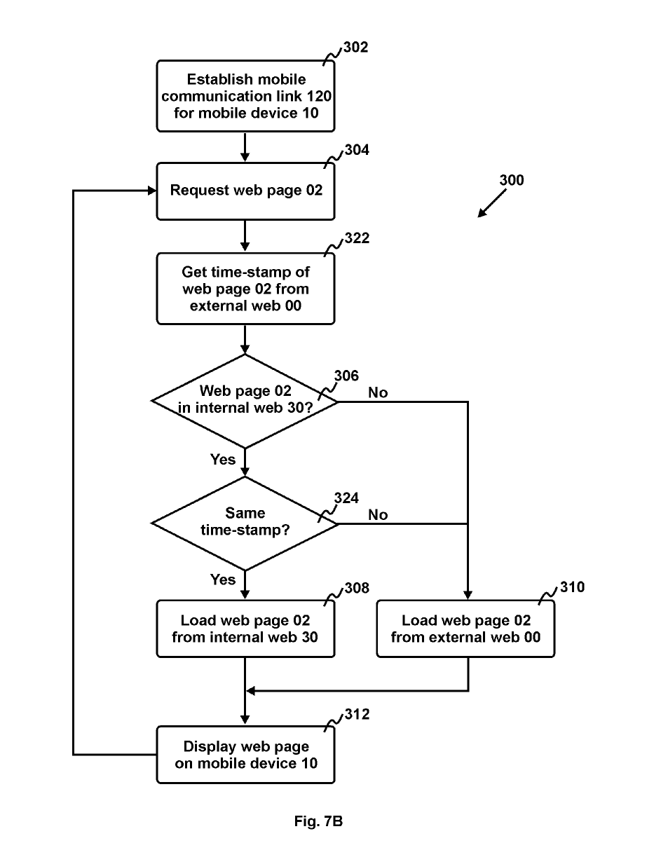

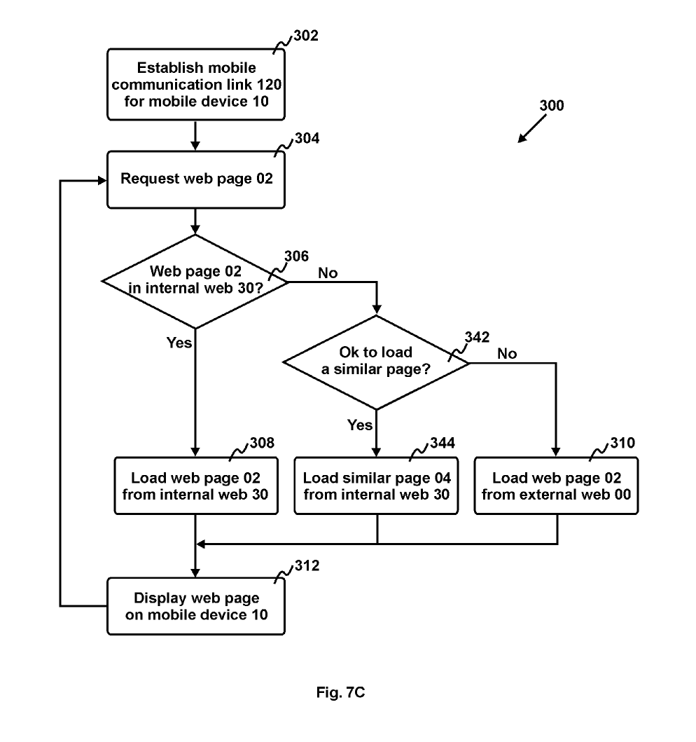

Referring now to FIGS. 7A-7C, three preferred information retrieval processes during a mobile Internet session 300 are disclosed. In FIG. 7A, a mobile communication link 120 is established for the mobile device 10 (step 302). Each time the mobile device 10 requests a web page 02 (step 304), the mobile device 10 first searches the web page 02 in the internal web 30 (step 306). If the result is “yes”, then the web page 02 is loaded from the internal web 30 (step 308); otherwise, the web page 02 is loaded from the external web 00 (step 310). Finally, the web page 02 is displayed on the mobile device 10 (step 312).

In FIG. 7B, the time-stamp of the web page 02 is retrieved from the external web 00 (step 322). It is further compared with the time-stamp of the web page 02 from the internal web 30 (step 324). If they are same, the web page 02 is loaded from the internal web 30; otherwise, the updated web page 02 is loaded from the external web 00 (step 310).

In FIG. 7C, if the web page 02 is not in the internal web (step 306), the user is prompted to accept a similar page from the internal web 30 (step 342). If the answer is “yes”, a similar page 04 is loaded from the internal web 30 and displayed in lieu of the requested web page 02 (step 344). This method can further reduce the mobile data usage.

While illustrative embodiments have been shown and described, it would be apparent to those skilled in the art that many more modifications than that have been mentioned above are possible without departing from the inventive concepts set forth therein. The invention, therefore, is not to be limited except in the spirit of the appended claims.

What is claimed is:

1. A mobile device for supporting location-based prefetch, comprising:
a mass-data transfer interface for retrieving location specific information associated with a scheduled future event via a mass-data transfer link prior to said scheduled future event, wherein said location specific information provides information associated with at least a future location of said scheduled future event, and said future location is inputted by a user prior to said scheduled future event;
a memory for storing said location specific information;
a mobile communication interface for retrieving requested information via a mobile communication link during said scheduled future event if said requested information is absent in said memory;
wherein said mobile device retrieves at least a portion of said location specific information from said memory during said scheduled future event.

2. The mobile device according to claim 1, wherein said scheduled future event is managed by a calendaring application.

3. The mobile device according to claim 1, wherein said mass-data transfer link is a non-mobile communication link.

4. The mobile device according to claim 3, wherein said non-mobile communication link is a local-area network (LAN) link.

5. The mobile device according to claim 3, wherein said non-mobile communication link is a wide-area network (WAN) link.

6. The mobile device according to claim 1, wherein said location specific information is retrieved via another mobile communication link during off-peak hours.

7. The mobile device according to claim 1, wherein said mobile communication link is a mobile broadband link.

8. The mobile device according to claim 1, wherein said location specific information further provides information associated with a future time of said scheduled future event.

9. The mobile device according to claim 1, wherein said location specific information further provides information associated with a future participant of said scheduled future event.

10. The mobile device according to claim 1, wherein said location specific information further provides information associated with a future action of said scheduled future event.

11. A mobile device for supporting participant-based prefetch, comprising:
a mass-data transfer interface for retrieving participant specific information associated with a scheduled future event via a mass-data transfer link prior to said scheduled future event, wherein said participant specific information provides information associated with at least a future participant of said scheduled future event, and said future participant is inputted by a user prior to said scheduled future event;
a memory for storing said participant specific information;
a mobile communication interface for retrieving requested information via a mobile communication link during said future event if said requested information is absent in said memory;
wherein said mobile device retrieves at least a portion of said participant specific information from said memory during said scheduled future event.

12. The mobile device according to claim 11, wherein said scheduled future event is managed by a calendaring application.

13. The mobile device according to claim 11, wherein said mass-data transfer link is a non-mobile communication link.

14. The mobile device according to claim 13, wherein said non-mobile communication link is a local-area network (LAN) link.

15. The mobile device according to claim 13, wherein said non-mobile communication link is a wide-area network (WAN) link.

16. The mobile device according to claim 11, wherein said location specific information is retrieved via another mobile communication link during off-peak hours.

17. The mobile device according to claim 11, wherein said mobile communication link is a mobile broadband link.

18. The mobile device according to claim 11, wherein said location specific information further provides information associated with a future time of said scheduled future event.

19. The mobile device according to claim 11, wherein said location specific information further provides information associated with a future location of said scheduled future event.

20. The mobile device according to claim 11, wherein said location specific information further provides information associated with a future action of said scheduled future event.
